(19) United States
(12) Patent Application Publication
(10) Pub. No.: US 2026/0079945 A1
(43) Pub. Date: Mar. 19, 2026

(54) INFORMATION PROCESSING APPARATUS, INFORMATION PROCESSING METHOD, AND NON-TRANSITORY COMPUTER READABLE STORAGE MEDIUM

(71) Applicant: LY Corporation, Tokyo (JP)

(72) Inventors: Kazuki ISHIKAWA, Tokyo (JP); Yuuki KANEKO, Tokyo (JP)

(21) Appl. No.: 19/299,041

(22) Filed: Aug. 13, 2025

(30) Foreign Application Priority Data
Sep. 19, 2024 (JP) 2024-162261

(51) Int. Cl. G06F 16/2457

(52) U.S. Cl. CPC G06F 16/2457

(57) ABSTRACT

An information processing apparatus according to the present applications includes a reception unit that receives, from a user, input of a search query in a predetermined search service, an identification unit that identifies an account that corresponds to the search query received by the reception unit and that is for a predetermined message service, and a providing unit that provides, to the user, account information that indicates the account identified by the identification unit, as a search result that corresponds to the search query.

### CROSS-REFERENCE TO RELATED APPLICATIONS

The present application claims priority to and incorporates by reference the entire contents of Japanese Patent Application No. 2024-162261 filed in Japan on Sep. 19, 2024.

### BACKGROUND OF THE INVENTION

### 1. Field of the Invention

The present invention relates to an information processing apparatus, an information processing method, and a non-transitory computer readable storage medium.

### 2. Description of the Related Art

Conventionally, a technology for providing various kinds of information to a user via the Internet is known. As one example of the technology as described above, a technology related to a search advertising for providing an advertisement corresponding to a search keyword that is input by a user is known.

However, in the conventional technology as described above, it is not always possible to provide information on an account in a message service in accordance with a search query that is input in a search service.

The present invention has been conceived in view of the foregoing situation, and an object of the present invention is to provide information on an account in a message service in accordance with a search query that is input in a search service.

### SUMMARY OF THE INVENTION

It is an object of the present invention to at least partially solve the problems in the conventional technology.

An information processing apparatus according to the present applications includes a reception unit that receives, from a user, input of a search query in a predetermined search service, an identification unit that identifies an account that corresponds to the search query received by the reception unit and that is for a predetermined message service, and a providing unit that provides, to the user, account information that indicates the account identified by the identification unit, as a search result that corresponds to the search query.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of information processing according to one embodiment;

FIG. 2 is a first diagram illustrating an example of a screen of a user terminal 100 according to one embodiment;

FIG. 3 is a second diagram illustrating an example of the screen of the user terminal 100 according to one embodiment;

FIG. 4 is a diagram illustrating a configuration example of an information processing apparatus 10 according to one embodiment;

FIG. 5 is a diagram illustrating an example of an OA information database 31;

FIG. 6 is a diagram illustrating an example of a user information database 32;

FIG. 7 is a flowchart illustrating an example of the flow of the information processing according to one embodiment; and

FIG. 8 is a hardware configuration diagram illustrating an example of a computer that implements functions of the information processing apparatus 10.

### DETAILED DESCRIPTION OF THE PREFERRED EMBODIMENTS

Modes (hereinafter, referred to as “embodiments”) for carrying out an information processing apparatus, an information processing method, and a non-transitory computer readable storage medium according to the present application will be described in detail below with reference to the drawings. Meanwhile, the information processing apparatus, the information processing method, and the non-transitory computer readable storage medium according to the present application are not limited by the embodiments below. Further, in each of the embodiments described below, the same components are denoted by the same reference symbols, and repeated explanation will be omitted.

### 1. Embodiment

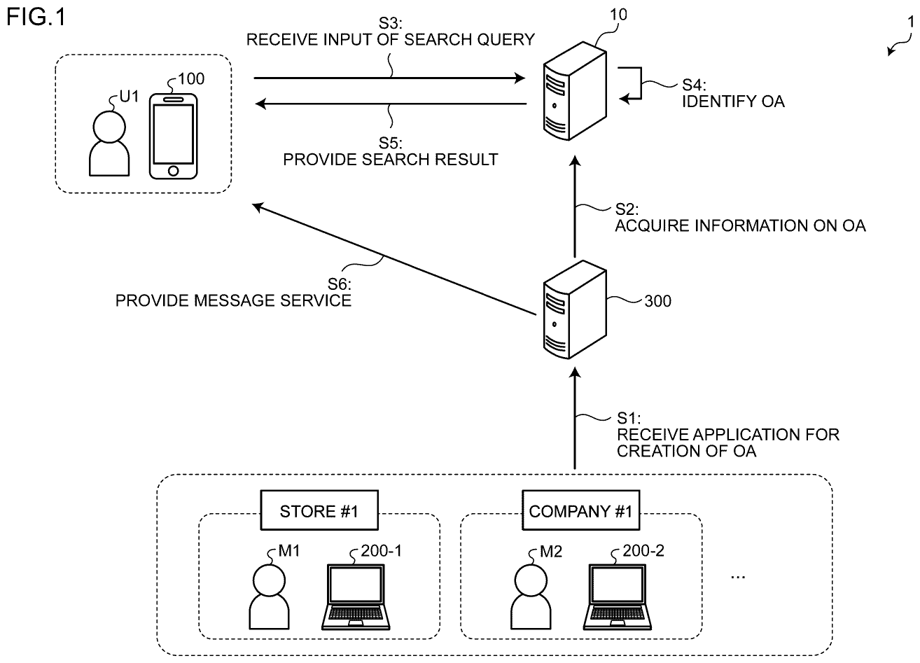

Information processing that is implemented by an information processing apparatus or the like according to one embodiment will be described below with reference to FIG. 1. FIG. 1 is a diagram illustrating an example of the information processing according to one embodiment. Meanwhile, in FIG. 1, an information processing apparatus 10 that is one example of the information processing apparatus according to the present application implements the information processing or the like according to one embodiment.

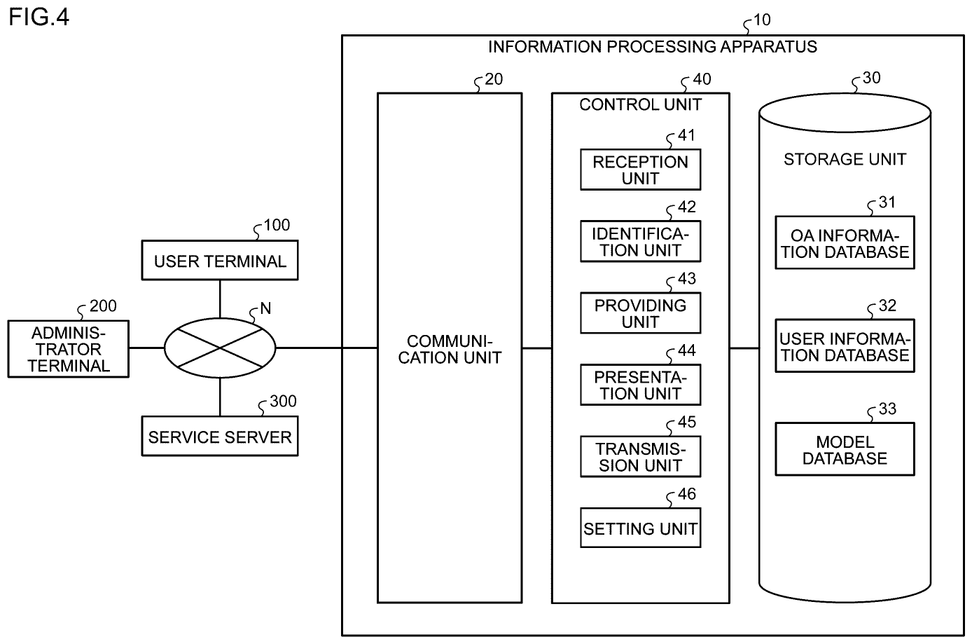

As illustrated in FIG. 1, an information processing system 1 according to one embodiment includes the information processing apparatus 10, a user terminal 100, an administrator terminal 200, and a service server 300. The information processing apparatus 10, the user terminal 100, the administrator terminal 200, and the service server 300 are communicably connected to one another in a wired or wireless manner via a network N (for example, see FIG. 4). The network N is, for example, a Wide Area Network (WAN), such as the Internet. Meanwhile, the information processing system 1 illustrated in FIG. 1 may include the plurality of information processing apparatuses 10, the plurality of user terminals 100, the plurality of administrator terminals 200, and the plurality of service servers 300.

The information processing apparatus 10 illustrated in FIG. 1 is an information processing apparatus that performs the information processing according to one embodiment, and is implemented by, for example, a server apparatus, a cloud system, or the like. In the example illustrated in FIG. 1, the information processing apparatus 10 provides a search service (search engine) #1 to a user.

Meanwhile, the information processing apparatus 10 may have a function as a web server that provides a web site for the search service #1. Further, the information processing apparatus 10 may be an apparatus that distributes, to the user terminal 100, the administrator terminal 200, or the like, information that is displayed on an application that is related to the search service and that is installed in the user terminal 100, the administrator terminal 200, or the like. Furthermore, the information processing apparatus 10 may be a server that distributes data itself of the application.

Moreover, the information processing apparatus 10 may function as a distribution apparatus that distributes control information to the user terminal 100, the administrator terminal 200, or the like. Here, the control information is written in, for example, a script language, such as JavaScript (registered trademark), or a style sheet language, such as Cascading Style Sheets (CSS). Meanwhile, the application that is distributed from the information processing apparatus 10 may be regarded as the control information.

The user terminal 100 illustrated in FIG. 1 is an information processing apparatus that is used by a user. The user terminal 100 is implemented by, for example, a smartphone, a tablet terminal, a notebook Personal computer (PC), a desktop PC, a mobile phone, a Personal Digital Assistant (PDA), or the like. Further, the user terminal 100 displays, by a web browser or an application, information that is distributed by the information processing apparatus 10, the service server 300, or the like. Meanwhile, in the example illustrated in FIG. 1, a case is illustrated in which the user terminal 100 is a smartphone.

The administrator terminal 200 illustrated in FIG. 1 is an information processing apparatus that is used by an administrator of a company or a store (for example, a real store, a store participating in an electronic commerce service, or the like). The administrator terminal 200 is implemented by, for example, a smartphone, a tablet terminal, a notebook Personal PC, a desktop PC, a mobile phone, a PDA, or the like. Further, the administrator terminal 200 displays, by a web browser or an application, information that is distributed by the information processing apparatus 10, the service server 300, or the like. Meanwhile, in the example illustrated in FIG. 1, a case is illustrated in which the administrator terminal 200 is a notebook PC.

The service server 300 illustrated in FIG. 1 provides, to a user, an administrator, or the like, a message service #1 that allows users to exchange messages or allow a user and an official account (for example, an account that is managed by an administrator of a company or a store) to exchange messages. As a specific example, the information processing apparatus 10 provides, to a user, the message service that allows exchange of a message with a different user who is associated with the user (in other words, a different user who is registered as a friend by the user) or an official account that is associated with the user (in other words, an official account that is registered as a friend by the user).

Meanwhile, the service server 300 may have a function as a web server that provides a web site for the message service #1. Further, the service server 300 may be an apparatus that distributes, to the user terminal 100, the administrator terminal 200, or the like, information that is displayed on an application that is related to the message service #1 and that is installed in the user terminal 100, the administrator terminal 200, or the like. Furthermore, the service server 300 may be a server that distributes data itself of the application.

Moreover, the service server 300 may function as a distribution apparatus that distributes control information to the user terminal 100, the administrator terminal 200, or the like. Here, the control information is written in, for example, a script language, such as JavaScript (registered trademark), or a style sheet language, such as CSS. Meanwhile, the application that is distributed from the service server 300 may be regarded as the control information.

An example of information processing that is performed by the information processing apparatus 10 will be described below with reference to FIG. 1. Meanwhile, in the following explanation, it is assumed that the user terminal 100 is used by a certain user (a user U1) who is identified by a user ID of “UID #1” in the search service #1. Further, in the following explanation, the user terminal 100 may be regarded as the user U1. In other words, in the following explanation, the user U1 may be replaced with the user terminal 100.

Furthermore, in the following explanation, it is assumed that an application (hereinafter, may be described as a “search application”) for providing the search service #1 and an application (hereinafter, may be described as a “message application”) for providing the message service #1 are installed in advance in the user terminal 100.

Moreover, in the following explanation, it is assumed that an account of the user U1 is already created in the message service #1. Furthermore, it is assumed that the information processing apparatus 10 associates the user ID of the user U1 in the search service #1 with a user ID of the user U1 in the message service #1, and manages the user IDs in a storage unit of the subject apparatus.

Meanwhile, the user ID in the search service #1 and the user ID in the message service #1 may be associated with each other in an arbitrary manner. As one example, the user U1 activates the message application that is installed in the user terminal 100, performs operation of logging in the search service #1 in a predetermined page (for example, an account center), and performs association. Furthermore, in the following explanation, administrator terminals 200-1 to 200-N (N is an arbitrary natural number) will be described in accordance with administrators who uses the administrator terminals 200. For example, the administrator terminal 200-1 is the administrator terminal 200 that is used by an administrator (for example, an administrator M1 who manages a store #1) who is identified by an administrator ID of “MID #1”. Moreover, the administrator terminal 200-2 is the administrator terminal 200 that is used by an administrator (for example, an administrator M2 who manages a company #1) who is identified by an administrator ID of “MID #2”.

Furthermore, in the following, when explanation is given without specifically distinguishing the administrator terminals 200-1 to 200-N, the administrator terminals are described as the administrator terminals 200. Moreover, in the following explanation, the administrator terminal 200 may be regarded as the administrator. In other words, in the following explanation, the administrator may be replaced with the administrator terminal 200.

Furthermore, in the following explanation, it is assumed that the message application is installed in advance in the administrator terminal 200.

First, the service server 300 receives, from the administrator terminal 200, application for creation of an official account (OA) of a store, a company, or the like that is managed by the administrator in the message service #1 (Step S1). For example, the service server 300 receives information on setting of the OA, and creates the OA based on the received information. As a specific example, the information processing apparatus 10 receives information, such as an explanatory text of the OA (for example, an explanatory text (description) of the store or the company that is managed by the administrator), a profile image, profile information including business hours of the store that is managed by the administrator, an address of the store that is managed by the administrator, or a Uniform Resource Locator (URL) of a Web site of the company or the store that is managed by the administrator, or a pricing plan (in other words, a usage fee for the message service #1).

When receiving the information on the setting of the OA, the service server 300 creates (opens) the OA of the company, the store, or the like based on the received information. Further, the service server 300 provides the profile information to the user via a profile page of the OA in the message service #1. Furthermore, the administrator manages the OA, and distributes information (message) related to the company, the store, or the like that is managed by the administrator to a user who has registered the OA as a friend in the message service #1.

Moreover, the user transmits a message, such as a question, to the OA that the user has registered as the friend in the message service #1, and exchanges messages with the OA. Furthermore, if needed, the user blocks the OA that is registered as the friend in the message service #1, and rejects reception of a message from the OA. Moreover, if needed, the user mutes the OA that is registered as the friend in the message service #1, and hides a message that is received from the OA.

Subsequently, the information processing apparatus 10 acquires the information on the OA from the service server 300 (Step S2). For example, the information processing apparatus 10 acquires information, such as the profile information or the pricing plan, that is the information on the setting of the OA. Further, the information processing apparatus 10 acquires information (for example, the user ID) on the user who has registered the OA as the friend, information on whether the user has blocked the OA, information on whether the user has muted the OA, or the like.

Subsequently, the information processing apparatus 10 receives, from the user terminal 100, input of a search query #1 in the search service #1 (Step S3). Then, the information processing apparatus 10 identifies an OA that corresponds to the search query #1 (Step S4). For example, the information processing apparatus 10 identifies an OA for which the profile information corresponds to the search query #1 from among OAs that have been registered as friends by the user U1 and that are muted or blocked. As a specific example, the information processing apparatus 10 identifies an OA for which the explanatory text includes a character string that is indicated by the search query #1 or a synonym or the like that is obtained by converting the character string by using thesaurus or the like. In the following, the OA that is identified at Step S4 may be described as an “identified OA”.

Subsequently, the information processing apparatus 10 provides a search result that corresponds to the search query #1 to the user terminal 100 via the search service #1 (Step S5). For example, the information processing apparatus 10 provides a search result that includes information (for example, a URL or a thumbnail image) on a web page that corresponds to the search query #1 and account information that indicates the identified OA. As a specific example, the information processing apparatus 10 provides, as the account information, information, such as the profile image or the explanatory text, on the identified OA.

Meanwhile, the information processing apparatus 10 may further include, in a search result, proposal information for proposing a next action of the user U1 after input of the search query #1, and provides the search result. For example, the information processing apparatus 10 generates the proposal information by using the search query #1 and a model #1 that is trained to generate an answer to an input question, includes the proposal information in a search result, and provides the search result. As a specific example, the information processing apparatus 10 generates the proposal information by inputting, to the model #1, the search query #1 and an instruction sentence for giving an instruction to output a next action of the user U1 based on the search query #1, and provides the proposal information.

As a more specific example, the information processing apparatus 10 provides the proposal information that indicates a search query that is recommended to be input by the user U1 following the search query #1. Further, the information processing apparatus 10 provides the proposal information that indicates a service that is recommended to be used by the user who has input the search query #1. As one example, the information processing apparatus 10 provides the proposal information that indicates an electronic commerce service for providing a product that is indicated by the search query #1.

Meanwhile, the model #1 is a model that is trained to output an answer sentence to an input question sentence, and is a language model, such as a Generative Pre-trained Transformer (GPT) or a Transformer, that performs natural language processing. Further, the model #1 is provided inside the information processing apparatus 10 and is originally generated by a business operator who manages the information processing apparatus 10. Meanwhile, it is desirable to perform training such that the input information is not used as a new answer to conceal information, such as input personal information.

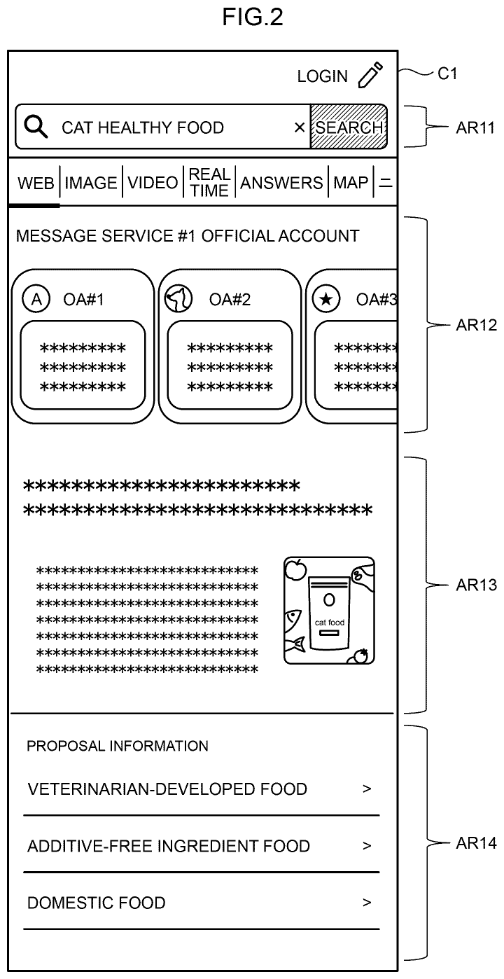

The search result that is provided to the user terminal 100 will be described below with reference to FIG. 2. FIG. 2 is a first diagram illustrating an example of a screen of the user terminal 100 according to one embodiment.

In the example illustrated in FIG. 2, the user terminal 100 displays a screen C1 that includes an area AR11 for inputting a search query, an area AR12 for displaying account information that indicates an identified OA corresponding to the search query that is input in the area AR11, an area AR13 for displaying information on a web page corresponding to the search query that is input in the area AR11, and an area AR14 for displaying proposal information based on the search query that is input in the area AR11.

For example, the user terminal 100 displays, in a carousel manner, the account information that indicates the profile image of the identified OA, the name of the identified OA, or the explanatory text of the identified OA, in the area AR12. Here, it is assumed that the user U1 selects any piece of the account information that is displayed in the area AR12. In this case, the user terminal 100 activates the message application and displays a page (for example, a profile page) of the OA that is indicated by the selected account information. Further, the user U1 performs operation, such as unblock or unmute of the identified OA, in the displayed page.

Referring back to FIG. 1, explanation will be continued. The service server 300 provides the message service #1 to the user terminal 100 (Step S6). For example, when the user U1 unblocks the identified OA at Step S5, the service server 300 provides a message that is transmitted from the identified OA to the user terminal 100. Further, when the user U1 unmutes the identified OA at Step S5, the service server 300 gives a notice related to a message that is transmitted from the identified OA.

As described above, the information processing apparatus 10 according to one embodiment identifies an OA that corresponds to a search query that is input by a user, and provides a search result that indicates account information indicating the identified OA. With this configuration, the information processing apparatus 10 according to one embodiment is able to provide information on an account in the message service in accordance with the search query that is input in the search service.

Further, conventionally, a frequency of contact with (a frequency of use of) the message service by the user may be high. Therefore, when a message, such as an advertisement, is to be transmitted from the OA to the user in the message service, the message service may frequently transmit a proactive message to the user. In other words, a message that is unrelated to an intent of the user may be frequently transmitted. In this case, the user may be bothered by the message that is transmitted from the OA in the message service, and block or mute the OA.

To cope with this, the information processing apparatus 10 according to one embodiment provides information on the OA that corresponds to the search query that is input by the user. In other words, the information processing apparatus 10 according to one embodiment provides the information on the corresponding OA in accordance with a proactive action, such as a search action, that is performed when the user needs information. With this configuration, the information processing apparatus 10 according to one embodiment is able to present the OA that indicates information that is needed by the user at a timing that is needed by the user and give an opportunity to unblock or unmute the OA, so that it is possible to allow the user to freely select a message that is transmitted form the OA in the message service.

Furthermore, conventionally, when the OA is blocked or muted in the message service, an opportunity of contact between the OA and the user may be lost and the OA remains blocked or muted, so that the user is not able to obtain needed information. To cope with this, according to the information processing apparatus 10 of one embodiment, it is possible to give an opportunity to unblock or unmute the OA in accordance with a proactive action, such as a search action, that is performed when the user needs information, so that it is possible to increase the possibility to unblock or unmute the OA and prevent loss of opportunity to provide information.

### 2. Examples of Other Processes

Meanwhile, the processes as described above are examples, and the information processing apparatus 10 may perform various kinds of processes by using various kinds of information. Examples of other processes will be described below.

### 2-1. OA That is not Registered as Friend

In the example illustrated in FIG. 1, the information processing apparatus 10 may provide, as the search result that corresponds to the search query #1, account information that indicates an OA that is not registered as a friend by the user U1 in the message service #1. For example, the information processing apparatus 10 identifies an OA that corresponds to the search query #1 and that is not registered as a friend by the user U1, and provides account information on the identified OA.

### 2-2. Permission of Provision of Account Information

The identified OA that is blocked or muted by the user U1 may include an OA for which the user U1 does not want to receive information. Therefore, in the example illustrated in FIG. 1, the information processing apparatus 10 may provide account information that indicates an OA that is permitted by the user U1 to be provided as a search result among identified OAs. For example, at Step S2, the information processing apparatus 10 acquires, as the information on the OA, information indicating whether or not the user who has registered the OA as a friend permits provision of the account information that indicates the OA. Further, the information processing apparatus 10 provides the account information that indicates an identified account that is permitted to be provided as the account information to the user terminal 100.

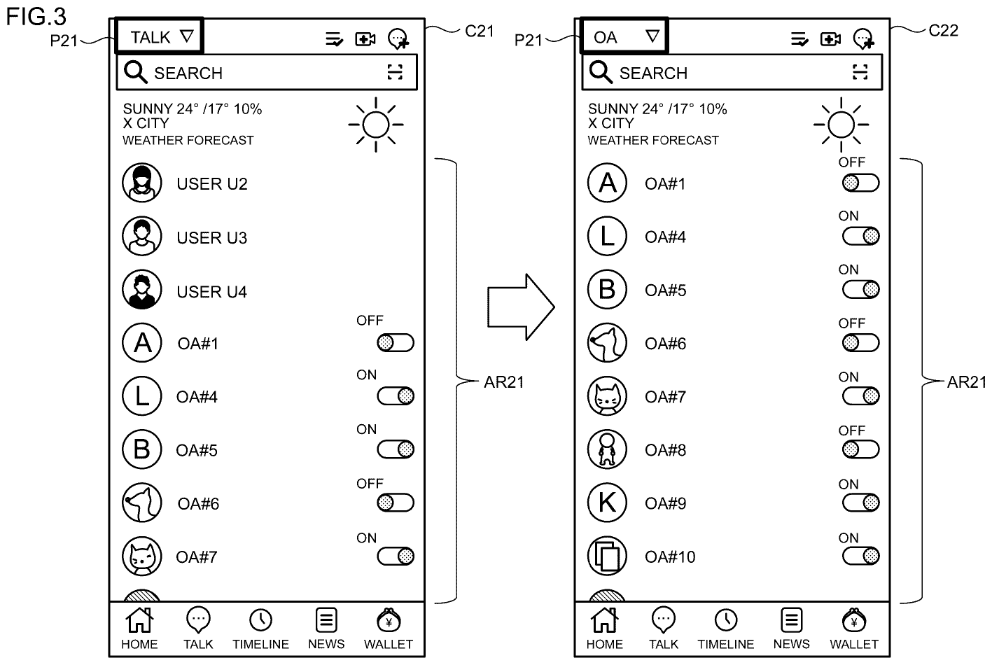

Meanwhile, operation (hereinafter, may be described as “designation operation”) of designating whether or not to permit provision of the account information may be performed by the user U1 in the message service #1. A screen that is displayed by the user terminal 100 for performing the designation operation in the message service #1 will be described below. FIG. 3 is a second diagram illustrating an example of the screen of the user terminal 100 according to one embodiment.

In the example illustrated in FIG. 3, the user terminal 100 displays a screen C21 that includes an area AR21 for displaying accounts (for example, different users or OAs) that are registered as friends by the user U1. For example, the user terminal 100 displays, in the screen C21, toggle buttons for performing the designation operation on OAs, together with the OAs. Further, when operation of moving (turning OFF) the toggle button to the left, the information processing apparatus 10 excludes account information that indicates an OA corresponding to the toggle button, from targets that are to be provided as search results. Furthermore, when operation of moving (turning ON) the toggle button to the right, the information processing apparatus 10 provides, to the user terminal 100, account information that indicates an OA corresponding to the toggle button, as a target to be provided as a search result.

Meanwhile, the user terminal 100 may display the screen C21 that includes a pull down P21 for performing operation of sorting accounts that are displayed on the screen. Further, when an “OA” is designated in the pull down P21, the user terminal 100 changes the screen C21 to a screen C22. For example, in the area AR21 of the screen C22, the user terminal 100 displays only OAs that are registered as friends by the user U1, and does not display accounts of other users that are registered as friends by the user U1.

### 2-3. Order of Provision of Account Information

In the example illustrated in FIG. 1, the information processing apparatus 10 may provide the account information in predetermined order. For example, the information processing apparatus 10 further acquires, at Step S2, a keyword that is designated by the administrator in relation to the OA. Furthermore, the information processing apparatus 10 provides the account information in order based on relevance between the search query #1 and the keyword that is designated in relation to the OA. As a specific example, the information processing apparatus 10 provides, from among a plurality of pieces of account information, a piece of account information that indicates an OA for which the keyword corresponds to the search query #1 in priority to the other pieces of account information.

Meanwhile, the information processing apparatus 10 may identify an OA for which the designated keyword corresponds to the search query #1 from among OAs that are registered as friends by the user U1, and provides the account information that indicates the identified OA.

Furthermore, the information processing apparatus 10 may provide the account information in order based on relevance between the search query #1 and an explanatory text of an OA. For example, the information processing apparatus 10 provides, with higher priority, account information on an OA for which a degree of match between the search query #1 and the explanatory text is higher. Moreover, the information processing apparatus 10 provides, with higher priority, account information on an OA for which the number of times of appearance of the search query #1 in the explanatory diagram is larger.

Furthermore, the information processing apparatus 10 may provide the account information in order based on relevance between an attribute of the user U1 and an attribute that is designated by an administrator of the OA. For example, the information processing apparatus 10 provides the account information in order based on relevance between a base (for example, a home, a workplace, a school, or the like) of the user U1 and a location of a store that is indicated by an OA. As a specific example, the information processing apparatus 10 provides, with higher priority, account information on an OA that indicates a store closer to the base of the user U1.

The attribute that is designated by the administrator of the OA may be an age, gender, or the like. In this case, when the attribute that is designated by the administrator of the OA coincides with the attribute of the user U1, the information processing apparatus 10 provides, with higher priority, the account information that indicates the OA.

Furthermore, the information processing apparatus 10 may provide the account information in order based on a usage fee that is paid by an administrator of the OA for the message service #1. For example, the information processing apparatus 10 provides, with higher priority, account information on an OA for which the usage fee that is paid by the administrator is higher.

### 2-4. Transmission of Message Indicating Search Query

In the example illustrated in FIG. 1, when the user U1 selects any piece of the account information, the information processing apparatus 10 may transmit the search query #1 to an OA that is indicated by the selected account information via the message service #1. For example, when the user U1 selects any piece of the account information, the information processing apparatus 10 activates the message application that is installed in the user terminal 100, and performs control of transmitting a message indicating the search query #1 from the account of the user U1 to the OA that is indicated by the selected account information. Thereafter, the administrator of the OA gives a reply to the message indicating the search query #1 via the message application.

### 2-5. Setting of Compensation for Administrator

In the example illustrated in FIG. 1, when the account information is provided to the user terminal 100, the information processing apparatus 10 may set, for the administrator of the OA that is indicated by the account information, a compensation for provision of the account information.

Furthermore, when the account information is provided and the user U1 performs conversion, the information processing apparatus 10 may set, for the administrator of the OA that is indicated by the account information, a compensation for provision of the account information. For example, when the user U1 selects account information, the information processing apparatus 10 sets a compensation for the administrator of the OA that is indicated by the account information.

Meanwhile, the information processing apparatus 10 may set, for the administrator of the OA, a compensation for provision of the account information when the user U1 performs conversion on the message service #1. For example, when the user U1 unblocks or unmutes the OA that is indicated by the account information after the account information is provided to the user terminal 100, the information processing apparatus 10 sets a compensation for the administrator of the OA.

Furthermore, when the user U1 transmits, on the message service #1, a message to the OA that is indicated by the account information after the account information is provided to the user terminal 100, the information processing apparatus 10 sets a compensation for the administrator of the OA.

Moreover, when a product that is proposed, by the OA that is indicated by the account information, to be purchased after the account information is proposed to the user terminal 100 is purchased in an electronic commerce service that is provided via the message service #1, the information processing apparatus 10 sets a compensation for the administrator of the OA.

Meanwhile, a compensation for provision of the account information need not always be set as described above, but may be set in an arbitrary method. For example, an administrator may designate a period in which the account information is provided or the number of times of provision of the account information, and a compensation may be set in accordance with the period or the number of times. In other words, the account information may be provided in a scheduled manner.

### 2-6. Explanatory Note Represented by the Account Information

In the example illustrated in FIG. 1, the information processing apparatus 10 may receive a plurality of explanatory texts for a single OA from the administrator terminal 200. Further, the information processing apparatus 10 may select an explanatory text corresponding to the search query #1 from among a plurality of explanatory texts of the identified OA, and provide account information that represents the selected explanatory text. For example, the information processing apparatus 10 provides, as the account information on the identified OA, an explanatory text for which a degree of match with the search query #1 is the highest from among the plurality of explanatory texts of the identified OA. Furthermore, the information processing apparatus 10 provides, as the account information on the identified OA, an explanatory text in which the number of times of appearance of the search query #1 is the highest from among the plurality of explanatory texts of the identified OA.

### 3. Configuration of Information Processing Apparatus

A configuration of the information processing apparatus 10 will be described below with reference to FIG. 4. FIG. 4 is a diagram illustrating a configuration example of the information processing apparatus 10 according to one embodiment. As illustrated in FIG. 4, the information processing apparatus 10 includes a communication unit 20, a storage unit 30, and a control unit 40.

### Communication Unit 20

The communication unit 20 is implemented by, for example, a Network Interface Card (NIC), or the like.

Further, the communication unit 20 is connected to the network N in a wired or wireless manner and transmits and receives information to and from the user terminal 100, the administrator terminal 200, the service server 300, or the like.

### Storage Unit 30

The storage unit 30 is implemented by, for example, a semiconductor memory device, such as a Random Access Memory (RAM) or a Flash Memory, or a storage device, such as a hard disk or an optical disk. As illustrated in FIG. 4, the storage unit 30 includes an OA information database 31, a user information database 32, and a model database 33.

### OA Information Database 31

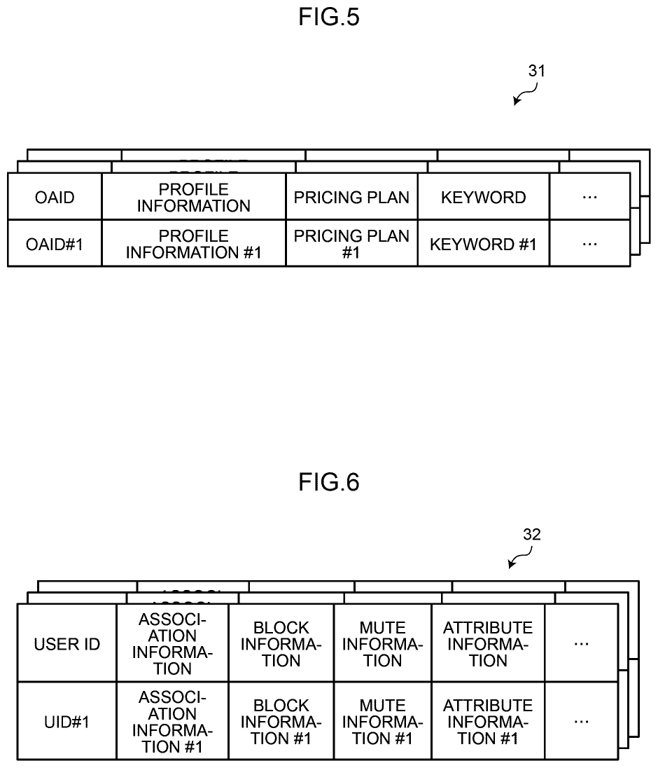

The OA information database 31 stores therein various kinds of information on the OA of the store, the company, or the like that is managed by the administrator. An example of the information that is stored in the OA information database 31 will be described below with reference to FIG. 5. FIG. 5 is a diagram illustrating an example of the OA information database 31. In the example illustrated in FIG. 5, the OA information database 31 includes items such as an “OA ID”, “profile information”, a “pricing plan”, and a “keyword”.

The “OA ID” indicates identification information for identifying an OA. The “profile information” indicates information on a profile of the OA, and stores therein, for example, information, such as the explanatory text of the OA, a profile image, business hours of the store that is managed by the administrator, an address of the store that is managed by the administrator, or a URL of a Web site of the company or the store that is managed by the administrator. The “pricing plan” indicates a usage fee of the OA in the message service #1. The “keyword” indicates a keyword that is designated by the administrator in relation to the OA.

Specifically, FIG. 5 illustrates an example in which profile information on an OA that is identified by the OA ID of “OAID #1” is “profile information #1”, a pricing plan is a “pricing plan #1”, and a keyword is a “keyword #1”.

### User Information Database 32

The user information database 32 stores therein various kinds of information on the user. An example of the information that is stored in the user information database 32 will be described below with reference to FIG. 6. FIG. 6 is a diagram illustrating an example of the user information database 32. In the example illustrated in FIG. 6, the user information database 32 includes items such as a “user ID”, “association information”, “block information”, “mute information”, and “attribute information”.

The “user ID” indicates identification information for identifying a user. The “association information” is information on an account of a different user or an OA that is registered as a friend by the user in the message service #1, and stores therein, for example, identification information (account ID) in the message service. The “block information” is information that indicates an account that is blocked by the user in the message service #1, and stores therein, for example, identification information in the message service #1. The “mute information” is information that indicates an account that is muted by the user in the message service #1, and stores therein, for example, identification information in the message service. The “attribute information” indicates information on an attribute of the user, and stores therein, for example, information that indicates a demographic attribute or a psychographic attribute.

Specifically, FIG. 6 illustrates an example in which association information on the user who is identified by the user ID of “UID #1” is “association information #1”, block information is “block information #1”, mute information is “mute information #1”, and attribute information is “attribute information #1”.

### Model Database 33

The model database 33 stores therein a model that is trained to output an answer to an input question.

### Control Unit 40

The control unit 40 is a controller and implemented by, for example, causing a Central Processing Unit (CPU), a Micro Processing Unit (MPU), or the like to execute various kinds of programs that are stored in a storage device inside the information processing apparatus 10 by using a RAM as a work area. Further, the control unit 40 is a controller and implemented by, for example, an integrated circuit, such as an Application Specific Integrated Circuit (ASIC) or a Field Programmable Gate Array (FPGA). The control unit 40 according to one embodiment includes, as illustrated in FIG. 4, a reception unit 41, an identification unit 42, a providing unit 43, a presentation unit 44, a transmission unit 45, and a setting unit 46, and implements or performs functions or operation of information processing as described below.

### Reception Unit 41

The reception unit 41 receives, from a user, input of a search query in a predetermined search service. For example, in the example illustrated in FIG. 1, the reception unit 41 receives, from the user terminal 100, input of the search query #1 in the search service #1.

Identification unit 42

The identification unit 42 identifies an account that corresponds to the search query received by the reception unit 41 and that is for a predetermined message service. For example, in the example illustrated in FIG. 1, the identification unit 42 refers to the storage unit 30 (for example, the OA information database 31) and identifies an OA that corresponds to the search query #1.

Furthermore, the identification unit 42 may identify the account that is associated with the user in the message service. For example, in the example illustrated in FIG. 1, the identification unit 42 identifies an OA for which the profile information corresponds to the search query #1 from among OAs that are registered as friends by the user U1.

Moreover, the identification unit 42 may identify the account that is associated with the user in the message service and that is blocked by the user. For example, in the example illustrated in FIG. 1, the identification unit 42 identifies an OA for which the profile information corresponds to the search query #1 from among OAs that are registered as friends and blocked by the user U1.

Furthermore, the identification unit 42 may identify the account that is associated with the user in the message service and that is muted by the user. For example, in the example illustrated in FIG. 1, the identification unit 42 identifies an OA for which the profile information corresponds to the search query #1 from among OAs that are registered as friends and muted by the user U1.

Moreover, the identification unit 42 may identify the account that is not associated with the user in the message service. For example, in the example illustrated in FIG. 1, the identification unit 42 identifies an OA that corresponds to the search query #1 and that is not registered as a friend by the user U1.

Providing unit 43

The providing unit 43 provides, to the user, account information that indicates the account that is identified by the identification unit 42, as a search result that corresponds to the search query. For example, in the example illustrated in FIG. 1, the providing unit 43 refers to the storage unit 30 (for example, the OA information database 31 or the user information database 32) and provides a search result that includes information on a web page corresponding to the search query #1 and includes account information that indicates the identified OA.

Furthermore, the providing unit 43 may provide the account information that indicates an account that is permitted by the user to be provided as a search result. For example, in the example illustrated in FIG. 1, the providing unit 43 may provide the account information that indicates an OA that is permitted by the user U1 to be provided as a search result from among the identified OAs.

Moreover, the providing unit 43 may input, to a model that is trained to generate an answer to an input question, the search query and an instruction sentence for giving an instruction to output a next action of the user from the search query, and further provide proposal information for proposing a next action to the user based on the output information. For example, in the example illustrated in FIG. 1, the providing unit 43 generates proposal information for proposing a next action of the user U1 after input of the search query #1 by inputting, to the model #1, the search query #1 and an instruction sentence for giving an instruction to output a next action of the user U1 based on the search query #1, and provides the proposal information.

Furthermore, the providing unit 43 may provide the account information in order based on relevance between the search query and a keyword that is designated by an administrator of the account. For example, in the example illustrated in FIG. 1, the providing unit 43 provides, from among a plurality of pieces of account information, a piece of account information that indicates an OA for which the keyword corresponds to the search query #1 in priority to the other pieces of account information.

Moreover, the providing unit 43 may provide the account information in order based on relevance between the search query and an explanatory text related to an account. For example, in the example illustrated in FIG. 1, the providing unit 43 provides, with higher priority, account information on an OA for which a degree of match between the search query #1 and the explanatory text is higher. Furthermore, the providing unit 43 provides, with higher priority, account information on an OA for which the number of times of appearance of the search query #1 in the explanatory text is higher.

Moreover, the providing unit 43 may provide the account information in order based on relevance between an attribute of the user and an attribute that is designated by an administrator of the account. For example, in the example illustrated in FIG. 1, the providing unit 43 provides, with higher priority, account information on an OA that indicates a store closer to the base of the user U1.

Furthermore, the providing unit 43 may provide the account information in order based on a usage fee that is paid by an administrator of the account for the message service. For example, in the example illustrated in FIG. 1, the providing unit 43 provides, with higher priority, account information on an OA for which the usage fee that is paid by the administrator is higher.

Moreover, the providing unit 43 may provide, as the account information, an explanatory text that corresponds to the search query among explanatory texts related to the account. For example, in the example illustrated in FIG. 1, the providing unit 43 selects an explanatory text corresponding to the search query #1 from among a plurality of explanatory texts, and provides account information that indicates the selected explanatory text.

Presentation unit 44

The presentation unit 44, when the user selects the account information, presents the account that is indicated by the selected account information to the user via the message service. For example, in the example illustrated in FIG. 1, when the user U1 selects any piece of the account information, the presentation unit 44 causes the user terminal 100 to activate the message application and display a page of an OA that is indicated by the selected account information.

Transmission unit 45

The transmission unit 45, when the user selects the account information, transmits the search query to the account that is indicated by the selected account information via the message service. For example, in the example illustrated in FIG. 1, when the user U1 selects any piece of the account information, the presentation unit 44 transmits the search query #1 to an OA that is indicated by the selected account information via the message service #1.

### Setting Unit 46

The setting unit 46, when the account information is provided to the user, sets, for an administrator of the account, a compensation for provision of the account information. For example, in the example illustrated in FIG. 1, when the account information is provided to the user terminal 100, the setting unit 46 sets, for the administrator of the OA that is indicated by the account information, a compensation for provision of the account information.

Furthermore, the setting unit 46 may set, for an administrator of the account, a compensation for provision of the account information in accordance with conversion that is performed by the user to whom the account information is provided. For example, in the example illustrated in FIG. 1, when the user U1 selects account information, the setting unit 46 sets a compensation for the administrator of the OA that is indicated by the account information.

Moreover, the setting unit 46 may set, for an administrator of the account, a compensation for provision of the account information in accordance with conversion that is performed by the user in the message service. For example, in the example illustrated in FIG. 1, when the user U1 performs conversion in the message service #1 after the account information is provided, the setting unit 46 sets, for the administrator of the OA that is indicated by the account information, a compensation for provision of the account information.

### 4. Flow of Information Processing

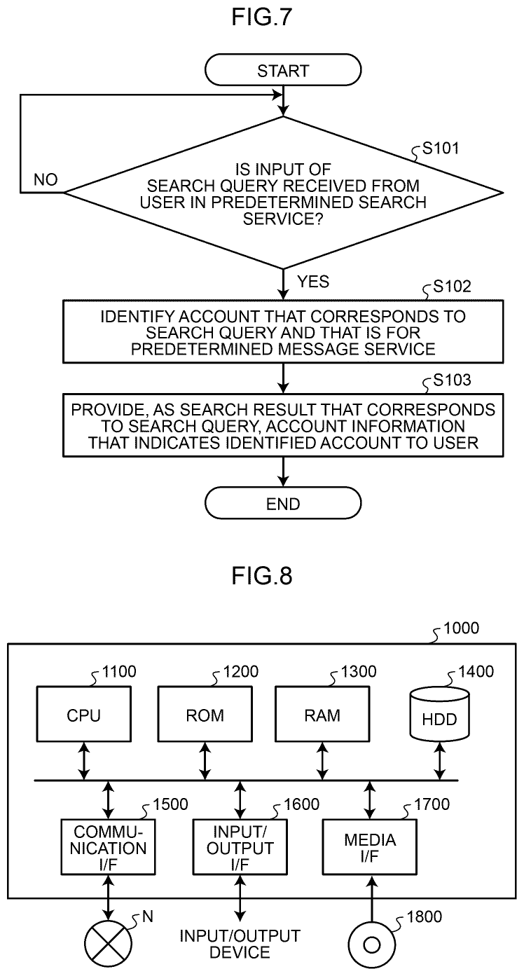

A flow of information processing that is performed by the information processing apparatus 10 according to one embodiment will be described below with reference to FIG. 7. FIG. 7 is a flowchart illustrating an example of the flow of the information processing according to one embodiment.

It is determined whether or not input of a search query is received from a user in a predetermined search service (Step S101). When input of the search query is not received from the user (Step S101; No), the information processing apparatus 10 waits until receiving input of the search query from the user.

In contrast, when receiving input of the search query from the user (Step S101; Yes), the information processing apparatus 10 identifies an account that corresponds to the search query and that is for the predetermined message service (Step S102). Subsequently, the information processing apparatus 10 provides, as a search result that corresponds to the search query, account information that indicates the identified account to the user (Step S103), and terminates the process.

### 5. Modification

The embodiments as described above are examples, and various changes and practical applications may be made.

### 5-1. Mode of Processes

Of the processes described in the embodiments above, all or part of a process described as being performed automatically may also be performed manually.

Alternatively, all or part of a process described as being performed manually may also be performed automatically by known methods. In addition, the processing procedures, specific names, and information including various kinds of data and parameters illustrated in the above-described document and drawings may be arbitrarily changed unless otherwise specified. For example, various kinds of information illustrated in each of the drawings are not limited to the information illustrated in the drawings.

Furthermore, the components of the apparatuses illustrated in the drawings are functionally conceptual and do not necessarily have to be physically configured in the manner illustrated in the drawings. In other words, specific forms of distribution and integration of the apparatuses are not limited to those illustrated in the drawings, and all or part of the apparatuses may be functionally or physically distributed or integrated in arbitrary units depending on various loads or use conditions.

Moreover, the embodiments as described above may be appropriately combined as long as processing contents do not conflict with each other.

### 6. Effects

As described above, the information processing apparatus 10 according to one embodiment includes the reception unit 41, the identification unit 42, the providing unit 43, the presentation unit 44, the transmission unit 45, and the setting unit 46. The reception unit 41 receives, from a user, input of a search query in a predetermined search service. The identification unit 42 identifies an account that corresponds to the search query received by the reception unit 41 and that is for a predetermined message service.

The providing unit 43 provides, to the user, account information that indicates the account that is identified by the identification unit 42, as a search result that corresponds to the search query. The presentation unit 44, when the user selects the account information, presents the account that is indicated by the selected account information to the user via the message service. The transmission unit 45, when the user selects the account information, transmits the search query to the account that is indicated by the selected account information via the message service. The setting unit 46, when the account information is provided to the user, sets, for an administrator of the account, a compensation for provision of the account information. Further, the setting unit 46 sets, for an administrator of the account, a compensation for provision of the account information in accordance with conversion that is performed by the user to whom the account information is provided. Furthermore, the setting unit 46 sets, for an administrator of the account, a compensation for provision of the account information in accordance with conversion that is performed by the user in the message service.

With this configuration, the information processing apparatus 10 according to one embodiment is able to identify an OA that corresponds to a search query that is input by a user and provide a search result that indicates account information that indicates the identified OA, so that it is possible to provide information on an account in the message service in accordance with the search query that is input in the search service.

Furthermore, in the information processing apparatus 10 according to one embodiment, for example, the identification unit 42 identifies the account that is associated with the user in the message service. Moreover, the identification unit 42 identifies the account that is associated with the user in the message service and that is blocked by the user. Furthermore, the identification unit 42 identifies the account that is associated with the user in the message service and that is muted by the user.

With this configuration, the information processing apparatus 10 according to one embodiment is able to present the OA that indicates information that is needed by the user at a timing needed by the user and give an opportunity to unblock or unmute the OA, so that it is possible to allow the user to freely select a message that is transmitted from the OA in the message service.

Moreover, in the information processing apparatus 10 according to one embodiment, for example, the identification unit 42 identifies the account that is not associated with the user in the message service.

With this configuration, the information processing apparatus 10 according to one embodiment is able to present an OA that indicates information that is needed by the user at a timing needed by the user, so that it is possible to allow the user to freely select a message that is transmitted from the OA in the message service.

Furthermore, in the information processing apparatus 10 according to one embodiment, for example, the providing unit 43 provides the account information that is permitted by the user to be provided as a search result.

With this configuration, the information processing apparatus 10 according to one embodiment is able to avoid providing information that is not desired by the user, so that it is possible to improve usability.

Moreover, in the information processing apparatus 10 according to one embodiment, for example, the providing unit 43 inputs, to a model that is trained to generate an answer to an input question, the search query and an instruction sentence for giving an instruction to output a next action of the user from the search query, and further provides proposal information for proposing a next action to the user based on output information.

With this configuration, the information processing apparatus 10 according to one embodiment is able to allow the user who has input the search query to recognize a next action to be taken, so that it is possible to improve usability.

Furthermore, in the information processing apparatus 10 according to one embodiment, for example, the providing unit 43 provides the account information in order based on relevance between the search query and a keyword that is designated by an administrator of the account. Moreover, the providing unit 43, provides the account information in order based on relevance between the search query and an explanatory text related to the account. Furthermore, the providing unit 43 provides the account information in order based on relevance between an attribute of the user and an attribute that is designated by an administrator of the account. Moreover, the providing unit 43 provides the account information in order based on a usage fee that is paid by an administrator of the account for the message service.

With this configuration, the information processing apparatus 10 according to one embodiment is able to provide the account information in order based on various criteria, so that it is possible to provide the account information in accordance with various needs.

### 7. Hardware configuration

The information processing apparatus 10 according to each of the embodiments as described above is implemented by, for example, a computer 1000 that is configured as illustrated in FIG. 8. In the following, explanation will be given by using the information processing apparatus 10 as an example. FIG. 8 a hardware configuration diagram illustrating an example of a computer that implements the functions of the information processing apparatus 10. The computer 1000 includes a CPU 1100, a ROM 1200, a RAM 1300, an HDD 1400, a communication interface (I/F) 1500, an input/output interface (I/F) 1600, and a media interface (I/F) 1700.

The CPU 1100 operates based on a program that is stored in the ROM 1200 or the HDD 1400, and controls each of the units. The ROM 1200 stores therein a boot program that is executed by the CPU 1100 at the time of activation of the computer 1000, a program that is dependent on hardware of the computer 1000, and the like.

The HDD 1400 stores therein a program that is executed by the CPU 1100, data that is used by the program, and the like. The communication interface 1500 receives data from a different apparatus via a communication network 500 (corresponding to the network N of one embodiment), sends the data to the CPU 1100, and transmits data that is generated by the CPU 1100 to a different apparatus via the communication network 500.

The CPU 1100 controls an output device, such as a display and a printer, and an input device, such as a keyboard or a mouse, via the input/output interface 1600. The CPU 1100 acquires data from the input device via the input/output interface 1600. Further, the CPU 1100 outputs generated data to the output device via the input/output interface 1600.

The media interface 1700 reads a program or data that is stored in a recording medium 1800, and provides the program or the data to the CPU 1100 via the RAM 1300. The CPU 1100 loads the program from the recording medium 1800 onto the RAM 1300 via the media interface 1700, and executes the loaded program. The recording medium 1800 is, for example, an optical recording medium, such as a Digital Versatile Disc (DVD) or a Phase change rewritable Disk (PD), a magneto-optical recording medium, such as a Magneto-Optical disk (MO), a tape medium, a magnetic recording medium, a semiconductor memory, or the like.

For example, when the computer 1000 functions as the information processing apparatus 10, the CPU 1100 of the computer 1000 executes a program that is loaded on the RAM 1300 and implements the functions of the control unit 40. Further, the HDD 1400 stores therein each piece of data in the storage device of the information processing apparatus 10. The CPU 1100 of the computer 1000 reads the programs from the recording medium 1800 and executes the programs; however, as another example, it may be possible to acquire the programs from a different apparatus via a predetermined communication network.

### 8. Others

Thus, embodiments of the present application have been described in detail above based on the drawings, but the embodiments are described by way of example, and the present invention may be made in various different modes with various modifications and improvement based on knowledge of a person skilled in the art, in addition to the embodiments described in the section of the disclosure of the invention.

Furthermore, the information processing apparatus 10 as described above may be implemented by calling an external platform or the like for some of the functions via an Application Programming Interface (API), network computing, or the like, and the configuration may be flexibly changed.

Moreover, the “unit” described in the appended claims may be replaced with a “means”, a “circuit”, or the like. For example, the receiving unit may be replaced with a receiving means or a receiving circuit.

According to one aspect of the embodiments, it is possible to provide information on an account in a message service in accordance with a search query that is input in a search service.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
a reception unit that receives, from a user, input of a search query in a predetermined search service;
an identification unit that identifies an account that corresponds to the search query received by the reception unit and that is for a predetermined message service; and
a providing unit that provides, to the user, account information that indicates the account that is identified by the identification unit, as a search result that corresponds to the search query.

2. The information processing apparatus according to claim 1, wherein the identification unit identifies the account that is associated with the user in the message service.

3. The information processing apparatus according to claim 1, wherein the identification unit identifies the account that is associated with the user in the message service and that is blocked by the user.

4. The information processing apparatus according to claim 1, wherein the identification unit identifies the account that is associated with the user in the message service and that is muted by the user.

5. The information processing apparatus according to claim 1, wherein the identification unit identifies the account that is not associated with the user in the message service.

6. The information processing apparatus according to claim 1, wherein the providing unit provides the account information that is permitted by the user to be provided as a search result.

7. The information processing apparatus according to claim 1, wherein the providing unit inputs, to a model that is trained to generate an answer to an input question, the search query and an instruction sentence for giving an instruction to output a next action of the user from the search query, and further provides proposal information for proposing a next action to the user based on output information.

8. The information processing apparatus according to claim 1, wherein the providing unit provides the account information in order based on relevance between the search query and a keyword that is designated by an administrator of the account.

9. The information processing apparatus according to claim 1, wherein the providing unit provides the account information in order based on relevance between the search query and an explanatory text related to the account.

10. The information processing apparatus according to claim 1, wherein the providing unit provides the account information in order based on relevance between an attribute of the user and an attribute that is designated by an administrator of the account.

11. The information processing apparatus according to claim 1, wherein the providing unit provides the account information in order based on a usage fee that is paid by an administrator of the account for the message service.

12. The information processing apparatus according to claim 1, wherein the providing unit provides, as the account information, an explanatory text that corresponds to the search query among explanatory texts related to the account.

13. The information processing apparatus according to claim 1, further comprising:
a presentation unit that, when the user selects the account information, presents the account that is indicated by the selected account information to the user via the message service.

14. The information processing apparatus according to claim 1, further comprising:
a transmission unit that, when the user selects the account information, transmits the search query to the account that is indicated by the selected account information via the message service.

15. The information processing apparatus according to claim 1, further comprising:
a first setting unit that, when the account information is provided to the user, sets, for an administrator of the account, a compensation for provision of the account information.

16. The information processing apparatus according to claim 1, further comprising:
a second setting unit that sets, for an administrator of the account, a compensation for provision of the account information in accordance with conversion that is performed by the user to whom the account information is provided.

17. The information processing apparatus according to claim 16, wherein the second setting unit sets, for an administrator of the account, a compensation for provision of the account information in accordance with conversion that is performed by the user in the message service.

18. An information processing method implemented by a computer, the information processing method comprising:
receiving, from a user, input of a search query in a predetermined search service;
identifying an account that corresponds to the search query received by the reception unit and that is for a predetermined message service; and
providing, to the user, account information that indicates the account identified by the identification unit, as a search result that corresponds to the search query.

19. A non-transitory computer readable storage medium having stored therein an information processing program that causes a computer to execute a process, the process comprising:
receiving, from a user, input of a search query in a predetermined search service;
identifying an account that corresponds to the search query received by the reception unit and that is for a predetermined message service; and
providing, to the user, account information that indicates the account identified by the identification unit, as a search result that corresponds to the search query.
